(19) United States
(12) Patent Application Publication
(10) Pub. No.: US 2020/0164995 A1
(43) Pub. Date: May 28, 2020

(54) FAULT-TOLERANT ELECTRICAL SYSTEMS FOR AIRCRAFT

(71) Applicant: A^3 by Airbus LLC, Sunnyvale, CA (US)

(72) Inventors: Zachary Thomas Lovering, Sunnyvale, CA (US); Geoffrey C. Bower, Sunnyvale, CA (US); Arne Stoschek, Palo Alto, CA (US); Herve Hilaire, San Jose, CA (US)

(73) Assignee: A^3 by Airbus LLC, Sunnyvale, CA (US)

(21) Appl. No.: 16/627,699

(22) PCT Filed: Jul. 2, 2018
(86) PCT No.: PCT/US2018/040643

§ 371 Date: Dec. 30, 2019

Related U.S. Application Data
(60) Provisional application No. 62/527,777, filed on Jun. 30, 2017.

(51) Int. Cl. B64D 31/06; B64C 39/08; B64D 27/24; B64C 9/00; B64C 13/50; B64C 39/02; B64D 35/02; B60L 50/60; B64C 29/00

(52) U.S. Cl. CPC B64D 31/06; B64C 39/08; B64D 27/24; B64C 9/00; B64C 13/50; B64C 39/024; B64C 2201/108; B60L 50/60; B64C 29/0033; B64D 2221/00; B64C 2201/02; B64C 2201/042; B64D 35/02

(57) ABSTRACT

An electric aircraft has a fault-tolerant electrical system designed to optimize competing concerns related to cost, performance, and safety. An electrical system in accordance with some embodiments of the present disclosure has a plurality of power sources (e.g., batteries) that are connected to other electrical components, such as motors for driving propellers or flight control surfaces, by a plurality of electrical buses. Each such bus is electrically isolated from the other buses to help the system better withstand electrical faults. Further, one or more of the electrical buses is connected to motors for driving multiple propellers. Selection of the propellers to be powered by energy received from the same bus is optimized so as to limit the effect of an electrical fault on the stability and controllability of the aircraft.

### CROSS REFERENCE TO RELATED APPLICATION

This application claims priority to International Application PCT/US2018/040643, entitled “FAULT-TOLERANT ELECTRICAL SYSTEMS FOR AIRCRAFT” and filed on Jul. 2, 2018, which is incorporated herein by reference. International Application PCT/US2018/040643 claims priority to U.S. Provisional Application No. 62/527,777, entitled “Fault-Tolerant Electrical Systems for Aircraft” and filed on Jun. 30, 2017, which is incorporated herein by reference.

### BACKGROUND

Electrically-powered aircraft offer various advantages and are becoming increasingly more common as an alternative to other types of aircraft powered by fuel. In this regard, electrically-powered aircraft operate more cleanly and oftentimes have a lower operating expense. In addition, electrically-powered aircraft can operate more quietly making this type of aircraft particularly attractive for use in applications involving flights near urban environments, including self-piloted aircraft designed for personal transport and package delivery.

Using electrical power to drive propulsion systems (e.g., propellers) of an aircraft significantly increases demands on the aircraft's electrical system, and it is important for the available electrical power to be efficiently used. Further, it is also important for the electrical system to be designed to withstand faults as electrical failure in an electrically-powered aircraft can be catastrophic. However, equipment used to safeguard an aircraft from electrical failure, such as isolated buses and redundant power sources, can increase cost and weight, which can limit the aircraft's range. The electrical system, including the safeguards that are used to protect the aircraft from electrical faults, should be efficiently designed and optimally balance various considerations, including safety, performance, and cost. Improved electrical systems that provide adequate power under various operating conditions while simultaneously safeguarding the aircraft from electrical faults in an efficient and robust manner are generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 depicts a perspective view of a self-piloted VTOL aircraft in accordance with some embodiments of the present disclosure.

FIG. 2A depicts a front view of a self-piloted VTOL aircraft, such as is depicted by FIG. 1, with flight control surfaces actuated for controlling roll and pitch.

FIG. 2B depicts a perspective view of a self-piloted VTOL aircraft, such as is depicted by FIG. 2A.

FIG. 3 is a block diagram illustrating various components of a VTOL aircraft, such as is depicted by FIG. 1.

FIG. 4 is a block diagram illustrating a flight-control actuation system, such as is depicted by FIG. 3, in accordance with some embodiments of the present disclosure.

FIG. 5 depicts a perspective view of a self-piloted VTOL aircraft, such as is depicted by FIG. 1, in a hover configuration in accordance with some embodiments of the present disclosure.

FIG. 6 depicts a top view of a self-piloted VTOL aircraft, such as is depicted by FIG. 5, in a hover configuration with the wings tilted such that thrust from wing-mounted propellers is substantially vertical.

FIG. 7 depicts a top view of a self-piloted VTOL aircraft in a hover configuration in accordance with some embodiments of the present disclosure.

FIG. 8 is a block diagram illustrating a portion of an electrical system for use in electrically-powered aircraft, such as is depicted by FIG. 1, in accordance with some embodiments of the present disclosure.

FIG. 9 is a block diagram illustrating another portion of the electrical system depicted by FIG. 8.

FIG. 10 is a block diagram illustrating a power source, such as is depicted by FIG. 8, in accordance with some embodiments of the present disclosure.

FIG. 11 is a block diagram illustrating an electrical bus, such as depicted by FIG. 8, equipped with fuses for isolating electrical faults in accordance with some embodiments of the present disclosure.

FIG. 12 is a block diagram illustrating a portion of an electrical system for use in electrically-powered aircraft, such as is depicted by FIG. 1, in accordance with some embodiments of the present disclosure.

FIG. 13 is a block diagram illustrating another portion of the electrical system depicted by FIG. 12.

FIG. 14 is a block diagram illustrating a computer system having optimization logic for optimizing one or more design parameters of an electrical power system in accordance with some embodiments of the present disclosure.

FIG. 15 is a block diagram illustrating various components of a VTOL aircraft, such as is depicted by FIG. 1, where a motor controller is electrically coupled to first motor for driving a first propeller.

FIG. 16 is a block diagram illustrating the embodiment of FIG. 15 where the motor controller is electrically coupled to a second motor for driving a second propeller.

FIG. 17 is a block diagram illustrating various components of a VTOL aircraft, such as is depicted by FIG. 1, where multiple motor controllers are selectively coupled the same set of motors for driving propellers.

### DETAILED DESCRIPTION

The present disclosure generally pertains to fault-tolerant electrical systems for electrically-powered aircraft. An electric aircraft in accordance with some embodiments of the present disclosure has a plurality of power sources (e.g., batteries) that are electrically connected to other electrical components, such as motors for driving propellers or flight control surfaces, by a plurality of electrical buses. Each such bus is electrically isolated from the other buses to help the system better withstand electrical faults. Further, in an effort to optimize the design of the electrical system, one or more of the electrical buses is connected to motors for driving multiple propellers. Selection of the propellers to be powered by energy received from the same bus is optimized so as to limit the effect of an electrical fault on the stability and controllability of the aircraft. As an example, the same bus may be electrically connected to motors driving corresponding propellers on opposite sides of the aircraft's fuselage so that roll and pitch remain balanced with sufficient yaw authority in the event that an electrical fault prevents the corresponding propellers from operating.

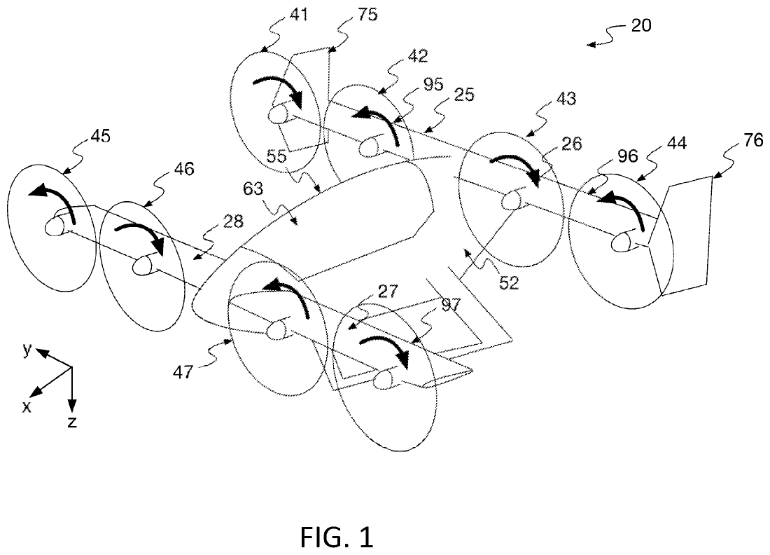

FIG. 1 depicts a vertical takeoff and landing (VTOL) aircraft 20 in accordance with some embodiments of the present disclosure. The aircraft 20 is autonomous or self-piloted in that it is capable of flying passengers or cargo to selected destinations under the direction of an electronic controller without the assistance of a human pilot. As used herein, the terms “autonomous” and “self-piloted” are synonymous and shall be used interchangeably. Further, the aircraft 20 is electrically powered thereby helping to reduce operation costs.

As shown by FIG. 1, the aircraft 20 has a tandem-wing configuration with a pair of rear wings 25, 26 mounted close to the rear of a fuselage 33 and a pair of forward wings 27, 28, which may also be referred to as “canards,” mounted close to the front of the fuselage 33. Each wing 25-28 has camber and generates lift (in the −z-direction) when air flows over the wing surfaces. The rear wings 25, 26 are mounted higher than the forward wings 27, 28 so as to keep them out of the wake of the forward wings 27, 28.

In the tandem-wing configuration, the center of gravity of the aircraft 20 is between the rear wings 25, 26 and the forward wings 27, 28 such that the moments generated by lift from the rear wings 25, 26 counteract the moments generated by lift from the forward wings 27, 28 in forward flight. Thus, the aircraft 20 is able to achieve pitch stability without the need of a horizontal stabilizer that would otherwise generate lift in a downward direction, thereby inefficiently counteracting the lift generated by the wings. In some embodiments, the rear wings 25, 26 have the same wingspan, aspect ratio, and mean chord as the forward wings 27, 28, but the sizes and configurations of the wings may be different in other embodiments. It should be emphasized the aircraft 20 depicted by FIG. 1 is presented for illustrative purposes and other type of aircraft, including piloted aircraft, aircraft having propellers or other propulsion devices powered by fuel, and aircraft having other types of wing configurations are possible. Exemplary embodiments of tandem-wing configurations are described by PCT Application No. PCT/US2017/18135, entitled “Vertical Takeoff and Landing Aircraft with Tilted-Wing Configurations” and filed on Feb. 16, 2017, which is incorporated herein by reference, and PCT Application No. PCT/US17/40413, entitled “Vertical Takeoff and Landing Aircraft with Passive Wing Tilt” and filed on Jun. 30, 2017, which is incorporated herein by reference.

In some embodiments, each wing 25-28 has a tilted-wing configuration that enables it to be tilted relative to the fuselage 33. In this regard, as will be described in more detail below, the wings 25-28 are rotatably coupled to the fuselage 33 so that they can be dynamically tilted relative to the fuselage 33 to provide vertical takeoff and landing (VTOL) capability and other functions, such as yaw control and improved aerodynamics, as will be described in more detail below.

A plurality of propellers 41-48 are mounted on the wings 25-28. In some embodiments, two propellers are mounted on each wing 25-28 for a total of eight propellers 41-48, as shown by FIG. 1, but other numbers of propellers 41-48 are possible in other embodiments. Further, it is unnecessary for each propeller to be mounted on a wing. As an example, the aircraft 20 may have one or more propellers (not shown) that are coupled to the fuselage 33, such as at a point between the forward wings 27, 28 and the rear wings 25, 26, by a structure (e.g., a rod or other structure) that does not generate lift. Such a propeller may be rotated relative to the fuselage 33 by rotating the rod or other structure that couples the propeller to the fuselage 33 or by other techniques.

For forward flight, the wings 25-28 and propellers 41-48 are positioned as shown by FIG. 1 such that thrust generated by the propellers 41-48 is substantially horizontal (in the x-direction) for moving the aircraft 20 forward. Further, each propeller 41-48 is mounted on a respective wing 25-28 and is positioned in front of the wing's leading edge such that the propeller blows air over the surfaces of the wing, thereby improving the wing's lift characteristics. For example, propellers 41, 42 are mounted on and blow air over the surfaces of wing 25; propellers 43, 44 are mounted on and blow air over the surfaces of wing 26; propellers 45, 46 are mounted on and blow air over the surfaces of wing 28; and propellers 47, 48 are mounted on and blow air over the surfaces of wing 27. Rotation of the propeller blades, in addition to generating thrust, also increases the speed of the airflow around the wings 25-28 such that more lift is generated by the wings 25-28 for a given airspeed of the aircraft 20. In other embodiments, other types of propulsion devices may be used to generate thrust, and it is unnecessary for each wing 25-28 to have a propeller or other propulsion device mounted thereon.

The end of each rear wing 25, 26 forms a respective winglet 75, 76 that extends generally in a vertical direction. The shape, size, and orientation (e.g., angle) of the winglets 75, 76 can vary in different embodiments. In some embodiments, the winglets 75, 76 are flat airfoils (without camber), but other types of winglets are possible. As known in the art, a winglet 75, 76 can help to reduce drag by smoothing the airflow near the wingtip helping to reduce the intensity of the wingtip vortex. The winglets 75, 76 also provide lateral stability about the yaw axis by generating aerodynamic forces that tend to resist yawing during forward flight. In other embodiments, the use of winglets 75, 76 is unnecessary, and other techniques may be used to control or stabilize yaw. Also, winglets may be formed on the forward wings 27, 28 in addition to or instead of the rear wings 25, 26.

For controllability reasons, which will be described in more detail below, it may be desirable to design the aircraft 20 such that the outer propellers 41, 44 on the rear wings 25, 26 do not rotate their blades in the same direction and the outer propellers 45, 48 on the forward wings 27, 28 do not rotate their blades in the same direction. Thus, in some embodiments, the outer propellers 44, 45 rotate their blades in a counter-clockwise direction opposite to that of the propellers 41, 48.

The fuselage 33 comprises a frame 52 on which a removable passenger module 55 and the wings 25-28 are mounted. The passenger module 55 has a floor (not shown in FIG. 1) on which at least one seat (not shown in FIG. 1) for at least one passenger is mounted. The passenger module 55 also has a transparent canopy 63 through which a passenger may see. The passenger module 55 may be removed from the frame 52 and replaced with a different module (e.g., a cargo module) for changing the utility of the aircraft 20, such as from passenger-carrying to cargo-carrying.

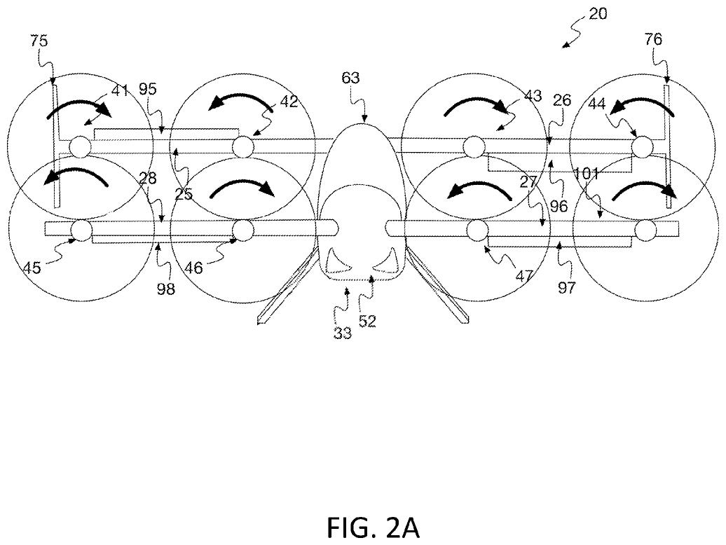

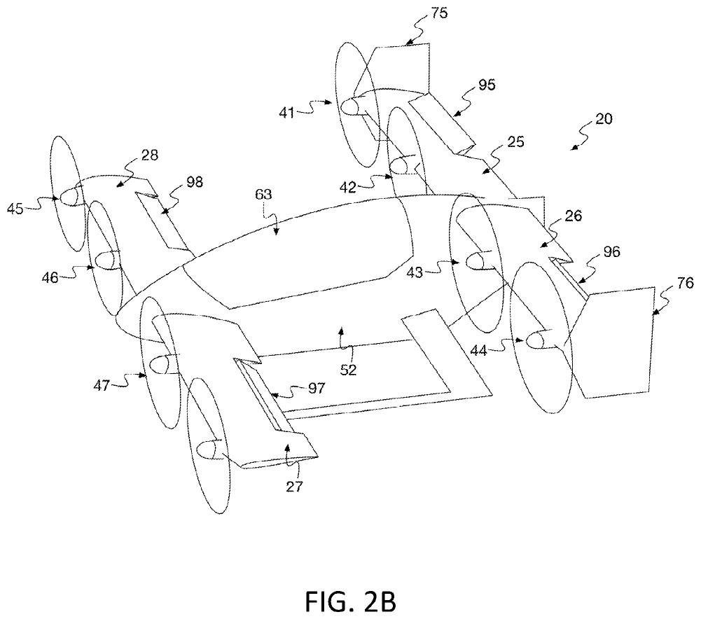

As shown by FIG. 2B, the wings 25-28 have hinged flight control surfaces 95-98, respectively, for controlling the roll and pitch of the aircraft 20 during forward flight. FIG. 1 shows each of the flight control surface 95-98 in a neutral position for which each flight control surface 95-98 is aligned with the remainder of the wing surface. Thus, airflow is not significantly redirected or disrupted by the flight control surfaces 95-98 when they are in the neutral position. Each flight control surface 95-98 may be rotated upward, which has the effect of decreasing lift, and each flight control surface 95-98 may be rotated downward, which has the effect of increasing lift.

In some embodiments, the flight control surfaces 95, 96 of rear wings 25, 26 may be used to control roll, and the flight control surfaces 97, 98 of forward wings 27, 28 may be used to control pitch. In this regard, to roll the aircraft 20, the flight control surfaces 95, 96 may be controlled in an opposite manner during forward flight such that one of the flight control surfaces 95, 96 is rotated downward while the other flight control surface 95, 96 is rotated upward, as shown by FIGS. 2A and 2B, depending on which direction the aircraft 20 is to be rolled. The downward-rotated flight control surface 95 increases lift, and the upward-rotated flight control surface 96 decreases lift such that the aircraft 20 rolls toward the side on which the upward-rotated flight control surface 96 is located. Thus, the flight control surfaces 95, 96 may function as ailerons in forward flight.

The flight control surfaces 97, 98 may be controlled in unison during forward flight. When it is desirable to increase the pitch of the aircraft 20, the flight control surfaces 97, 98 are both rotated downward, as shown by FIGS. 2A and 2B, thereby increasing the lift of the wings 27, 28. This increased lift causes the nose of the aircraft 20 to pitch upward. Conversely, when it is desirable for the aircraft 20 to pitch downward, the flight control surfaces 97, 98 are both rotated upward thereby decreasing the lift generated by the wings 27, 28. This decreased lift causes the nose of the aircraft 20 to pitch downward. Thus, the flight control surfaces 97, 98 may function as elevators in forward flight.

Note that the flight control surfaces 95-98 may be used in other manners in other embodiments. For example, it is possible for the flight control surfaces 97, 98 to function as ailerons and for the flight control surfaces 95, 96 to function as elevators. Also, it is possible for any flight control surface 95-98 to be used for one purpose (e.g., as an aileron) during one time period and for another purpose (e.g., as an elevator) during another time period. Indeed, as will be described in more detail below, it is possible for any of the flight control surfaces 95-98 to control yaw depending on the orientation of the wings 25-28.

During forward flight, pitch, roll, and yaw may also be controlled via the propellers 41-48. As an example, to control pitch, the controller 110 may adjust the blade speeds of the propellers 45-48 on the forward wings 27, 28. An increase in blade speed increases the velocity of air over the forward wings 27, 28, thereby increasing lift on the forward wings 27, 28 and, thus, increasing pitch. Conversely, a decrease in blade speed decreases the velocity of air over the forward wings 27, 28, thereby decreasing lift on the forward wings 27, 28 and, thus, decreasing pitch. The propellers 41-44 may be similarly controlled to provide pitch control. In addition, increasing the blade speeds on one side of the aircraft 20 and decreasing the blade speeds on the other side can cause roll by increasing lift on one side and decreasing lift on the other. It is also possible to use blade speed to control yaw. Having redundant mechanisms for flight control helps to improve safety. For example, in the event of a failure of one or more flight control surfaces 95-98, the controller 110 may be configured to mitigate for the failure by using the blade speeds of the propellers 41-48.

It should be emphasized that the wing configurations described above, including the arrangement of the propellers 41-48 and flight control surfaces 95-98, as well as the size, number, and placement of the wings 25-28, are only examples of the types of wing configurations that can be used to control the aircraft's flight. Various modifications and changes to the wing configurations described above would be apparent to a person of ordinary skill upon reading this disclosure.

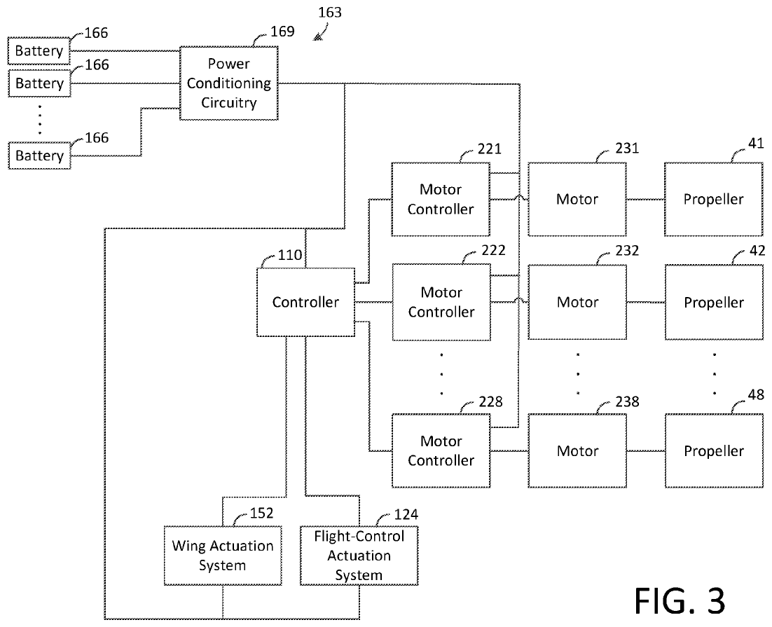

Referring to FIG. 3, the aircraft 20 may operate under the direction and control of an onboard controller 110, which may be implemented in hardware or any combination of hardware, software, and firmware. The controller 110 may be configured to control the flight path and flight characteristics of the aircraft 20 by controlling at least the propellers 41-48, the wings 25-28, and the flight control surfaces 95-98, as will be described in more detail below.

The controller 110 is coupled to a plurality of motor controllers 221-228 where each motor controller 221-228 is configured to control the blade speed of a respective propeller 41-48 based on control signals from the controller 110. As shown by FIG. 3, each motor controller 221-228 is coupled to a respective motor 231-238 that drives a corresponding propeller 41-48. When the controller 110 determines to adjust the blade speed of a propeller 41-48, the controller 110 transmits a control signal that is used by a corresponding motor controller 221-238 to set the rotation speed of the propeller's blades, thereby controlling the thrust provided by the propeller 41-48.

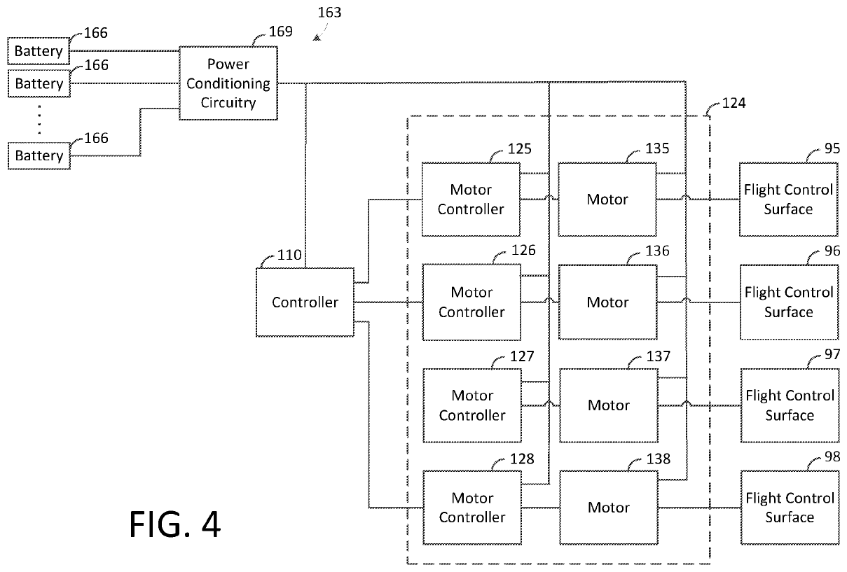

The controller 110 is also coupled to a flight-control actuation system 124 that is configured to control movement of the flight control surfaces 95-98 under the direction and control of the controller 110. FIG. 4 depicts an embodiment of the flight-control actuation system 124. As shown by FIG. 4, the system 124 comprises a plurality of motor controllers 125-128, which are coupled to a plurality of motors 135-138 that control movement of the flight control surfaces 95-98, respectively. The controller 110 is configured to provide control signals that can be used to set the positions of the flight control surfaces 95-98 as may be desired.

As shown by FIG. 3, the controller 110 is coupled to a wing actuation system 152 that is configured to rotate the wings 25-28 under the direction and control of the controller 110. As further shown by FIG. 3, the aircraft 20 has an electrical power system 163 for powering various components of the aircraft 20, including the controller 110, the motor controllers 221-228, 125-128, and the motors 231-238, 135-138. In some embodiments, the motors 231-238 for driving the propellers 41-48 are exclusively powered by electrical power from the system 163, but it is possible for other types of motors 231-238 (e.g., fuel-fed motors) to be used in other embodiments. Further, in some embodiments, each motor 231-238 is electrically connected to the electrical power system 163 through one or more motor controllers 221-228, which control propeller speed by controlling the amount of electrical power that is delivered to the propellers 41-48. For simplicity of illustration, FIG. 3 shows one motor controller 221-228 per motor 231-238, but there may be more than one motor controller per motor in other embodiments. In such an embodiment having multiple motor controllers per motor, if one motor controller fails, the motor coupled to the failed motor controller may continue to receive electrical power from at least one other motor controller. Similarly, it is also possible for a single propeller 41-48 to be driven by more than one motor.

The electrical system 163 has distributed power sources comprising a plurality of batteries 166 that are mounted on the frame 52 at various locations. Each of the batteries 166 is coupled to power conditioning circuitry 169 that receives electrical power from the batteries 166 and conditions such power (e.g., regulates voltage) for distribution to the electrical components of the aircraft 20. Specifically, the power conditioning circuitry 169 may combine electrical power from multiple batteries 166 to provide one or more direct current (DC) power signals for the aircraft's electrical components. If any of the batteries 166 fail, the remaining batteries 166 may be used to satisfy the power requirements of the aircraft 20.

As described above, in some embodiments, the wings 25-28 are configured to rotate under the direction and control of the controller 110. FIG. 1 shows the wings 25-28 positioned for forward flight in a configuration referred to herein as “forward-flight configuration” in which the wings 25-28 are positioned to generate sufficient aerodynamic lift for counteracting the weight of the aircraft 20 as may be desired for forward flight. In such forward-flight configuration, the wings 25-28 are generally positioned close to horizontal, as shown by FIG. 1, so that the chord of each wing 25-28 has an angle of attack for efficiently generating lift for forward flight. The lift generated by the wings 25-28 is generally sufficient for maintaining flight as may be desired.

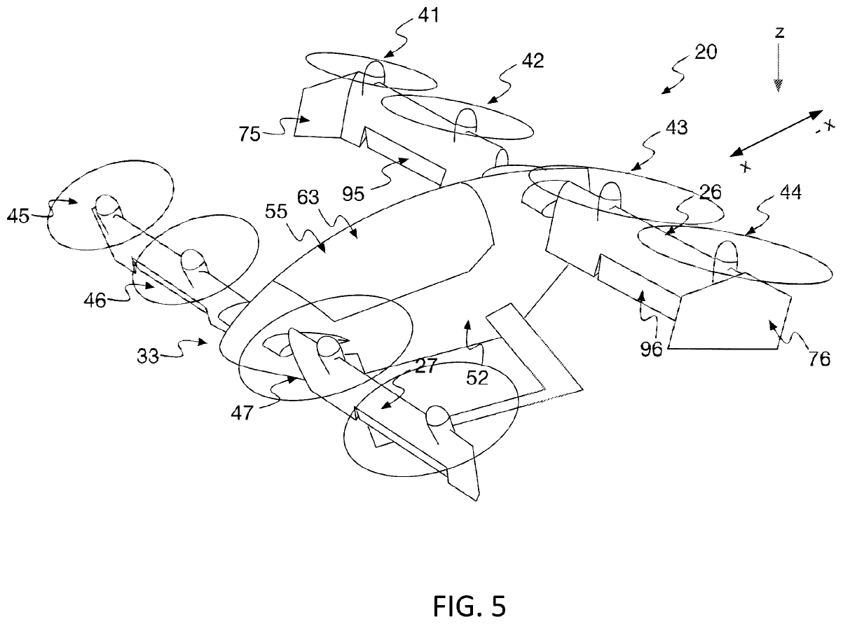

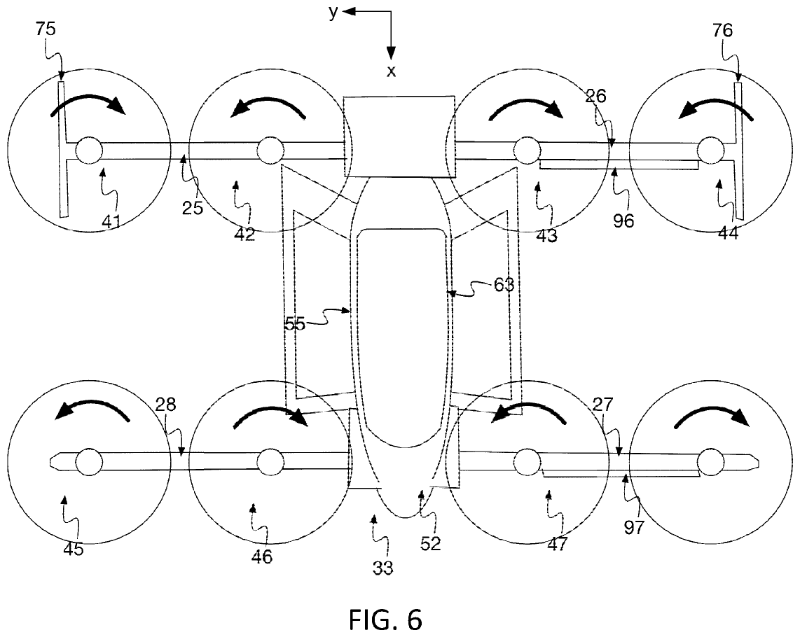

When desired, such as when the aircraft 20 nears its destination, the wings 25-28 may be rotated in order to transition the configuration of the wings 25-28 from the forward-flight configuration shown by FIG. 1 to a configuration, referred to herein as “hover configuration,” conducive for performing vertical takeoffs and landings. In the hover configuration, the wings 25-28 are positioned such that the thrust generated by the propellers 41-48 is sufficient for counteracting the weight of the aircraft 20 as may be desired for vertical flight. In such hover configuration, the wings 25-28 are positioned close to vertical, as shown by FIG. 5, so that thrust from the propellers 41-48 is generally directed upward to counteract the weight of the aircraft 20 in order to achieve the desired vertical speed, although the thrust may have a small offset from vertical for controllability, as will be described in more detail below. A top view of the aircraft 20 in the hover configuration with the wings 25-28 rotated such that the thrust from the propellers is substantially vertical is shown by FIG. 6.

Note that the direction of rotation of the propeller blades, referred to hereafter as “blade direction,” may be selected based on various factors, including controllability while the aircraft 20 is in the hover configuration. In some embodiments, the blade directions of the outer propellers 41, 45 on one side of the fuselage 33 mirror the blade directions of the outer propellers 44, 48 on the other side of the fuselage 33. That is, the outer propeller 41 corresponds to the outer propeller 48 and has the same blade direction. Further, the outer propeller 44 corresponds to the outer propeller 45 and has the same blade direction. Also, the blade direction of the corresponding outer propellers 44, 45 is opposite to the blade direction of the corresponding outer propellers 41, 48. Thus, the outer propellers 41, 44, 45, 48 form a mirrored quad arrangement of propellers having a pair of diagonally-opposed propellers 41, 48 that rotate their blades in the same direction and a pair of diagonally-opposed propellers 44, 45 that rotate their blades in the same direction.

In the exemplary embodiment shown by FIG. 5, the outer propellers 41, 48 are selected for a clockwise blade direction (when viewed from the front of the aircraft 20), and the outer propellers 44, 45 are selected for a counter-clockwise blade direction (when viewed from the front of the aircraft 20). However, such selection may be reversed, if desired so that blades of propellers 41, 48 rotate counter-clockwise and blades of propellers 44, 45 rotate clockwise.

In addition, the blade directions of the inner propellers 42, 46 on one side of the fuselage 33 mirror the blade directions of the inner propellers 43, 47 on the other side of the fuselage 33. That is, the inner propeller 42 corresponds to the inner propeller 47 and has the same blade direction. Further, the inner propeller 43 corresponds to the inner propeller 46 and has the same blade direction. Also, the blade direction of the corresponding inner propellers 43, 46 is opposite to the blade direction of the corresponding inner propellers 42, 47. Thus, the inner propellers 42, 43, 46, 47 form a mirrored quad arrangement of propellers having a pair of diagonally-opposed propellers 42, 47 that rotate their blades in the same direction and a pair of diagonally-opposed propellers 43, 46 that rotate their blades in the same direction. In other embodiments, the aircraft 20 may have any number of quad arrangements of propellers, and it is unnecessary for the propellers 41-48 to be positioned in the mirrored quad arrangements described herein.

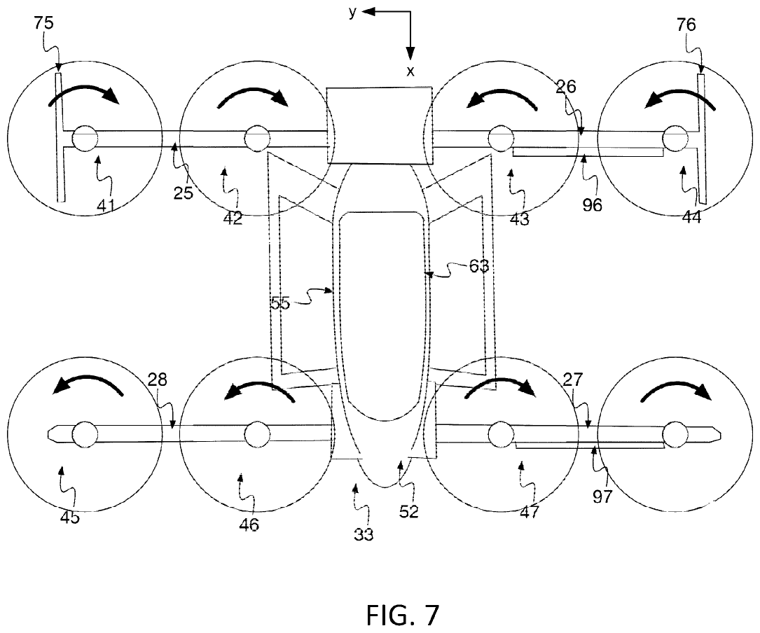

In the exemplary embodiment shown by FIG. 5, the corresponding inner propellers 42, 47 are selected for a counter-clockwise blade direction (when viewed from the front of the aircraft 20), and the corresponding inner propellers 43, 46 are selected for a clockwise blade direction (when viewed from the front of the aircraft 20). This selection has the advantage of ensuring that portions of the rear wings 25, 26 on the inboard side of propellers 42, 43 stall due to the upwash from propellers 42, 43 before the portions of the wings 25, 26 on the outboard side of the propellers 42, 43. This helps to keep the airflow attached to the surface of the wings 25, 26 where the flight control surfaces 95, 96 are located as angle of attack increases, thereby helping to keep the flight control surfaces 95, 96 functional for controlling the aircraft 20 as a stall is approached. However, such selection may be reversed, if desired, so that blades of propellers 42, 47 rotate clockwise and blades of propellers 43, 46 rotate counter-clockwise, as shown by FIG. 7. Yet other blade direction combinations are possible in other embodiments.

By mirroring the blade directions in each quad arrangement, as described above, certain controllability benefits can be realized. For example, corresponding propellers (e.g., a pair of diagonally-opposed propellers within a mirrored quad arrangement) may generate moments that tend to counteract or cancel so that the aircraft 20 may be trimmed as desired. The blade speeds of the propellers 41-48 can be selectively controlled to achieve desired roll, pitch, and yaw moments. As an example, it is possible to design the placement and configuration of corresponding propellers (e.g., positioning the corresponding propellers about the same distance from the aircraft's center of gravity) such that their pitch and roll moments cancel when their blades rotate at certain speeds (e.g., at about the same speed). In such case, the blade speeds of the corresponding propellers can be changed (i.e., increased or decreased) at about the same rate or otherwise for the purposes of controlling yaw, as will be described in more detail below, without causing roll and pitch moments that result in displacement of the aircraft 20 about the roll axis and the pitch axis, respectively. By controlling all of the propellers 41-48 so that their roll and pitch moments cancel, the controller 110 can vary the speeds of at least some of the propellers to produce desired yawing moments without causing displacement of the aircraft 20 about the roll axis and the pitch axis. Similarly, desired roll and pitch movement may be induced by differentially changing the blade speeds of propellers 41-48. In other embodiments, other techniques may be used to control roll, pitch, and yaw moments.

Differential torque from the propeller motors 231-238 can be used to control yaw in the hover configuration. In this regard, due to air resistance acting on the spinning blades of a propeller 41-48, a spinning propeller 41-48 applies torque on the aircraft 20 through the motor 231-238 that is spinning its blades. This torque generally varies with the speed of rotation. By varying the speeds at least some of the propellers 41-48 differently, differential toque can be generated by the spinning propellers 41-48 for causing the aircraft 20 to yaw or, in other words, rotate about its yaw axis. Other techniques may also be used to control yaw, such as deflection of the flight control surfaces 95-98 and tilting of the wings 25-28, as described by PCT Application No. PCT/US2017/18135.

It is generally desirable for the electrical power system 163 to be fault tolerant so that electrical faults, such as a short, do not cause the entire system 163 to fail. Indeed, in aircraft, failures of certain electrically-powered components, such as the propellers 45-48, can be catastrophic, and ensuring robustness of the electrical power system 163 is an important safety concern. It is possible to design the electrical power system 163 to be very robust in withstanding electrical faults such that a single fault affects a minimal number of components. However, increasing the robustness of the electrical power system 163 can increase complexity, cost, and overall weight of the system 163. Thus, trade-offs exist between the robustness of the system 163 and other considerations, including cost and performance. It is generally desirable for the electrical power system 163 to be efficiently designed to provide an optimized solution balancing many competing factors, including safety, cost, and performance among others.

In one embodiment, the motor and motor controller of each propeller 41-48 is coupled to a separate power source by a separate electrical bus that is electrically isolated from other electrical buses in the system 163. Thus, for the aircraft 10 depicted by FIG. 6, there are at least eight separate power sources and eight separate electrical buses for feeding power to the motors and motor controllers used to drive and control the propellers 41-48. If a fault (e.g., a short) occurs on any one bus or power source, only the propeller driven by the motor connected to the faulty power source or bus is affected. By limiting an electrical fault to a single propeller 41-48, the electrical system 163 is highly robust, but requiring eight separate buses increases the cost and weight of the system 163.

In another embodiment, each electrical bus is coupled to the motors and motor controllers for a pair of propellers 41-48 such that only four separate buses are required for an embodiment having eight propellers, as shown by FIG. 6. By reducing the number of electrical buses, the cost and weight of the electrical system 163 can be decreased, but using a fewer number of electrically isolated buses also adds the risk that a fault on a given bus or power source may affect the operation of a greater number (two in the instant case) of propellers 41-48. In other embodiments, a given electrical bus can be connected to the motors and motor controllers for any number of propellers 41-48 and to any number of power sources. As the number of propellers per bus increases, generally the greater is the possible effect of an electrical fault on the performance and controllability of the aircraft 10.

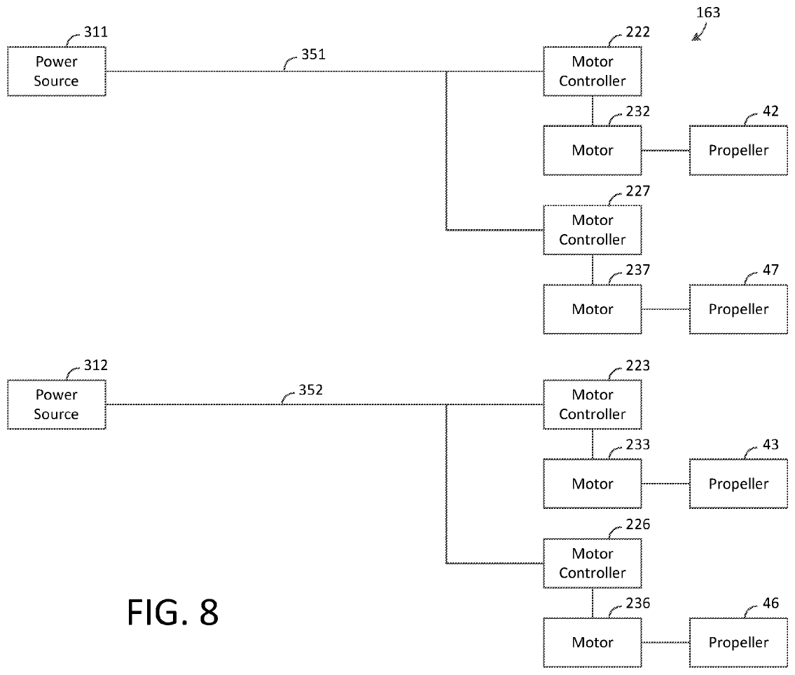

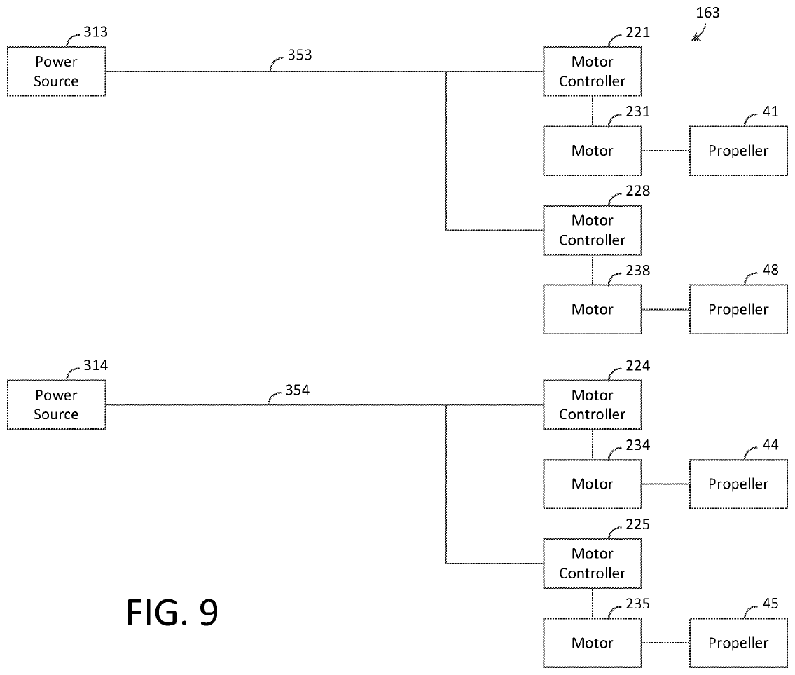

FIGS. 8 and 9 depict an exemplary embodiment of an electrical system 163 that attempts to optimize various competing considerations, including safety, cost, and performance, by connecting the motors and motor controllers for multiple propellers 41-48 to each respective power source. Specifically, as shown by FIG. 8, the electrical system 163 has a power source 311 electrically coupled to the motor controller 222 and motor 232 of propeller 42 by an electrical bus 351 for delivering electrical power from the power source 311 to the motor controller 222 and motor 232. The power source 311 is also electrically coupled to the motor controller 227 and motor 237 of propeller 47 by the electrical bus 351 for delivering electrical power from the power source 311 to the motor controller 227 and motor 237. In addition, the electrical system 163 has a power source 312 electrically coupled to the motor controller 223 and motor 233 of propeller 43 by an electrical bus 352 for delivering electrical power from the power source 312 to the motor controller 223 and motor 233. The power source 312 is also electrically coupled to the motor controller 226 and motor 236 of propeller 46 by the electrical bus 352 for delivering electrical power from the power source 312 to the motor controller 226 and motor 236.

As shown by FIG. 9, the electrical system 163 has a power source 313 electrically coupled to the motor controller 221 and motor 231 of propeller 41 by an electrical bus 353 for delivering electrical power from the power source 313 to the motor controller 221 and motor 231. The power source 313 is also electrically coupled to the motor controller 228 and motor 238 of propeller 48 by the electrical bus 353 for delivering electrical power from the power source 313 to the motor controller 228 and motor 238. In addition, the electrical system 163 has a power source 314 electrically coupled to the motor controller 224 and motor 234 of propeller 44 by an electrical bus 354 for delivering electrical power from the power source 314 to the motor controller 224 and motor 234. The power source 314 is also electrically coupled to the motor controller 225 and motor 235 of propeller 45 by the electrical bus 354 for delivering electrical power from the power source 314 to the motor controller 225 and motor 235.

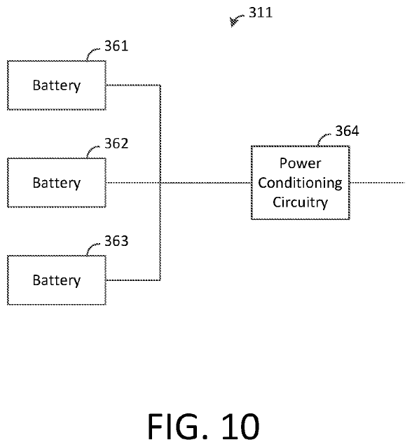

Each power source 311-314 is designed to provide electrical power to the electrical components coupled to it and may comprise any number of batteries or other types of devices for sourcing power. FIG. 10 shows an exemplary embodiment of a power source 311 having a plurality of batteries 361-363 connected in parallel to power conditioning circuitry 364 that conditions a power signal sourced from the batteries 361-363 for transmission across the electrical bus 351 that is connected to the power source 311. The power conditioning circuitry 364 may perform various conditioning (e.g., voltage regulation) of the power signal as may be desired. FIG. 10 shows three batteries for illustrative purposes, but the power source 311 may have any number of batteries or other power sourcing devices in other embodiments. The other power sources 312-314 may be configured similar to the one shown by FIG. 10.

Notably, each electrical bus 351-354 is electrically isolated from the other electrical buses so that a fault associated with any single electrical bus 351-354 should not affect the other electrical buses and the components coupled to them. Thus, any single electrical fault should not affect the operation of more than two propellers in the instant embodiment where each electrical bus 351-354 is connected to the motors and motor controllers for only two propellers 41-48. Further, as will be described in more detail below, steps may be taken to attempt to isolate a fault so that it has even less of an effect on the operation of the aircraft 10.

In addition, the propellers that are paired together for receiving power from the same electrical bus are strategically selected so as to mitigate the effects of an electrical fault to the controllability of the aircraft 10, thereby helping the aircraft 10 to better withstand an electrical fault. In this regard, the propeller pairs are selected such that diagonally-opposed propellers that generate corresponding pitch and roll moments, which substantially cancel when each propeller operates at about the same speed, are connected to the same bus. Thus, if both propellers of the pair are operating at about the same speed, then loss of both propellers should not generate any substantial net pitch or roll moments that would have to be compensated by the remaining propellers that are operational to keep the aircraft stable. Indeed, the pitch and roll moments remain balanced if the operation of both diagonally-opposed propellers is lost.

As an example, as described above, propellers 41, 48 are diagonally opposed and thus generate corresponding pitch and roll moments when they operate at the same speed. Specifically, an increase in the operational speeds of propellers 41, 48 blows air faster across the wings 25, 28, respectively, thereby causing each wing 25, 28 to generate more lift where the airflows from propellers 41, 48 pass over the wings 25, 28. Further, each propeller 41, 48 is located about the same distance (in the y-direction) from the aircraft's center of gravity and on opposite sides of the fuselage 33 such that the moment about the roll axis generated by the additional lift induced by the propeller 41 substantially cancels the moment about the roll axis generated by the additional lift induced by the propeller 48. In addition, each propeller 41, 48 is located about the same distance (in the x-direction) from the aircraft's center of gravity, which is between the rear wings 25, 26 and forward wings 27, 28 such that the moment about the pitch axis generated by the additional lift induced by the propeller 41 substantially cancels the moment about the pitch axis generated by the additional lift induced by the propeller 48.

Further, as described above, the motors 231, 238, as well as the corresponding motor controllers 221, 228 for the propellers 41, 48 are connected to and receive electrical power from the same electrical bus 353. Thus, an electrical fault on the bus 353 that prevents the motors 231, 238 from operating results in the operational loss of both propellers 41, 48. As described above, since the propellers 41, 48 generate corresponding pitch and roll moments that tend to cancel at the same rotational speed, the loss of both propellers 41, 48 should not generate any net pitch or roll moments that would need to be compensated by the other propellers 42-47 to keep the aircraft 10 stable about the pitch axis and roll axis.

Thus, when multiple propellers are to receive power from the same electrical bus, pairing the motors driving corresponding (e.g., diagonally-opposed) propellers on opposite sides of the fuselage 33 for connection to the same electrical bus has the benefit of reducing the effects of an electrical fault on controllability. Further, limiting each bus to just one pair of corresponding propellers also helps to reduce the effect of an electrical fault on the operation of the aircraft 10. However, it should be noted that other numbers of propeller pairs may be connected to the same bus as may be desired while still realizing controllability benefits for the pairings. As an example, it is possible to use the same electrical bus to provide power for driving both pairs of propellers in the same quad arrangement. In particular, the motors 222, 223, 226, 227 for driving propellers 42, 43, 46, 47 of the inner quad arrangement may be connected to the same electrical bus, or the motors 221, 224, 225, 228 for driving the propellers 41, 44, 45, 48 of the outer quad arrangement may be connected to the same electrical bus. In the event of an electrical fault on either bus, either the propellers of the inner quad arrangement or the propellers 41, 44, 45, 48 of the outer quad arrangement should remain operational for providing thrust and controlling pitch, roll, and yaw. Further, pitch and roll remain balanced in the event of the loss of operation of propellers in either the inner quad arrangement or the outer quad arrangement. Other combinations are possible as well. For example, the motors 221, 223, 226, 228 for driving the propellers 41, 43, 46, 48 may be connected to the same electrical bus, or the motors 222, 224, 225, 227 for driving the propellers 42, 44, 45, 47 may be connected to the same electrical bus. In such an embodiment, pitch and roll should remain balanced in the event of an electrical fault on either bus. The motors for any number of pairs of diagonally-opposed propellers that generate corresponding pitch and roll moments may be connected to the same bus in yet other embodiments.

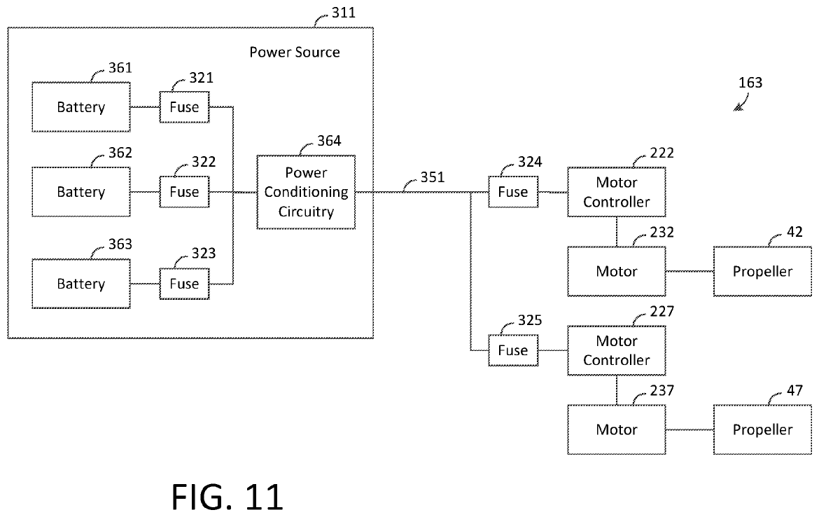

In some embodiments, fuses may be used to isolate certain electrical faults from affecting all of the components connected to the same bus. Such fuses may be used to mitigate against the risks of connecting more components to the same electrical bus. As an example, FIG. 11 shows the electrical bus 351 for the embodiment of FIG. 8 connected to a plurality of inline fuses 321-325 for electrically isolating faults. Ordinarily, each fuse 321-325 operates in a short-circuit state in which the fuse allows current to pass. However, each fuse 321-325 is designed to automatically transition to an open-circuit state when the current or voltage of the power signal passing through it exceeds a predefined threshold. There are various types of fuses that may be used. In one exemplary embodiment, each fuse 321-325 is implemented as a pyrotechnic fuse, which has a detector for detecting current or voltage of the signal passing through it. Such a fuse also has a pyrotechnic component that is triggered by the detector to explode when the current or voltage reaches a threshold, thereby severing the conductive connection passing through it. Such severance creates an open circuit that prevents current from passing through the fuse. In other embodiments, other types of fuses may be used as desired.

Referring to FIG. 11, fuses 321-323 are respectively connected to the bus 351 in series with and near the batteries 361-363 of the power source 311. In the event of an electrical fault (e.g., short) associated with the battery 361, the fuse 321 is responsive to the increased current or voltage resulting from such fault to transition from a short-circuit state to an open-circuit state thereby electrically isolating the battery 361 from the other components connected to the bus 351. In such an example, the motor controllers 222, 227 and motors 232, 237 for the propellers 42, 47 may receive electrical power from the other batteries 362, 363 and remain operational. Similarly, in the event of an electrical fault associated with either of the batteries 362, 363, the fuse 322, 323 connected in series with the faulty battery 362, 363 is responsive to the increased current or voltage resulting from such fault to transition from a short-circuit state to an open-circuit state thereby electrically isolating the faulty battery 362, 363 from the other components connected to the bus 351. Thus, the propellers 42, 47, should remain operational in the event of an electrical fault associated with any of the batteries 361-363.

As shown by FIG. 11, fuses may be similarly positioned in series with and near the other components connected to the bus 351 for isolating electrical faults associated with the other components. As an example, fuses 324, 325 may be positioned in series with and near the motor controllers 222, 227 and motors 232, 237, respectively, as shown by FIG. 11. Thus, in the event of an electrical fault (e.g., short) associated with any motor or motor controller of FIG. 11, a corresponding fuse in series with such motor or motor controller transitions to an open-circuit state to isolate the electrical fault from the other components connected to the bus 351. Therefore, such an electrical fault should affect the operation of only one propeller (i.e., the propeller driven or controlled by the faulty motor or motor controller). Note that fuses may be similarly used to isolate electrical faults in other embodiments. As an example, fuses may be similarly used for the electrical buses 352-354 depicted by FIGS. 8 and 9

Note that the power sources 311-314 used to power the propellers 41-48 may be used to power other components, such as the flight control surfaces 95-98. Selection of which power source 311-314 is used to power which flight control flight control surface 95-98 may be optimized to provide better controllability in the event of an electrical fault, as will be described in more detail below.

In this regard, some of the flight control surfaces 95-98 may be designed to generate greater moments and, thus, have a greater impact on pitch, roll, or yaw relative to other flight control surfaces 95-98 due to their respective locations or sizes. In this regard, a flight control surface 95-98 located a greater distance from the aircraft's center of gravity should generate a greater moment for the same force vector relative to another flight control surface 95-98 that is located closer to the aircraft's center of gravity. Also, a flight control surface 95-98 that is designed similar to another flight control surface but has a larger surface area should generally generate a greater force (e.g., lift) and, thus, moment. Therefore, flight control surfaces 95-98 that are larger (thereby generating greater forces) and located a greater distance from the aircraft's center of gravity (thereby generating a greater moment for a given force) generally have a greater effect on aircraft controllability.

Similarly, a propeller 41-48 located a greater distance from the aircraft's center of gravity should generate a greater moment for the same thrust relative to another propeller 41-48 that is located closer to the aircraft's center of gravity. Also, a propeller 41-48 that provides a greater thrust should generally generate a greater moment. Thus, propellers 41-48 that generate greater thrust and are located a greater distance from the aircraft's center of gravity generally have a greater effect on aircraft controllability.

In some embodiments, selection of which power source 311-315 is used to power which flight control surface 95-98 and propeller 41-48 is based on the relative effect of each flight control surface 95-98 and propeller 41-48 on the controllability of the aircraft 10. Specifically, a propeller 41-48 that has a greater effect on aircraft controllability (relative to other propellers) is powered by the same power source 311-314 used to power a flight control surface 95-98 having a lesser effect on aircraft controllability (relative to other flight control surfaces) so that the overall impact to aircraft controllability will be less in the event of an electrical fault. Similarly, a propeller 41-48 that has a lesser effect on aircraft controllability (relative to other propellers) is powered by the same power source 311-314 used to power a flight control surface 95-98 having a greater effect on aircraft controllability (relative to other flight control surfaces) so that the overall impact to aircraft controllability will be less in the event of an electrical fault. To better illustrate the foregoing, an exemplary configuration for the electrical system 163 in an embodiment for the aircraft 10 will be described in more detail below.

In this regard, assume that the propellers 41-48 are of the same size and designed to generate the same thrust, though such thrust may be differentially controlled for controllability. In such case, the outer propellers 41, 44, 45, 48 generally have a greater effect on aircraft controllability relative to the inner propellers 42, 43, 46, 47. In addition, assume that that flight control surfaces 97, 98 on the forward wings 27, 28 have a slightly smaller size, thereby generally generating smaller forces and moments, relative to the flight control surfaces 95, 96 on the rear wings 25, 26 such that the flight control surfaces 95, 96 have a greater effect on aircraft controllability relative to the flight control surfaces 97, 98. In such an example, the flight control surfaces 95, 96 having a greater effect on aircraft controllability (relative to the other flight control surfaces 97, 98) are connected to the same electrical buses as inner propellers 42, 43, 46, 47 having a lesser effect on aircraft stability and controllability (relative to the outer propellers 41, 44, 45, 48).

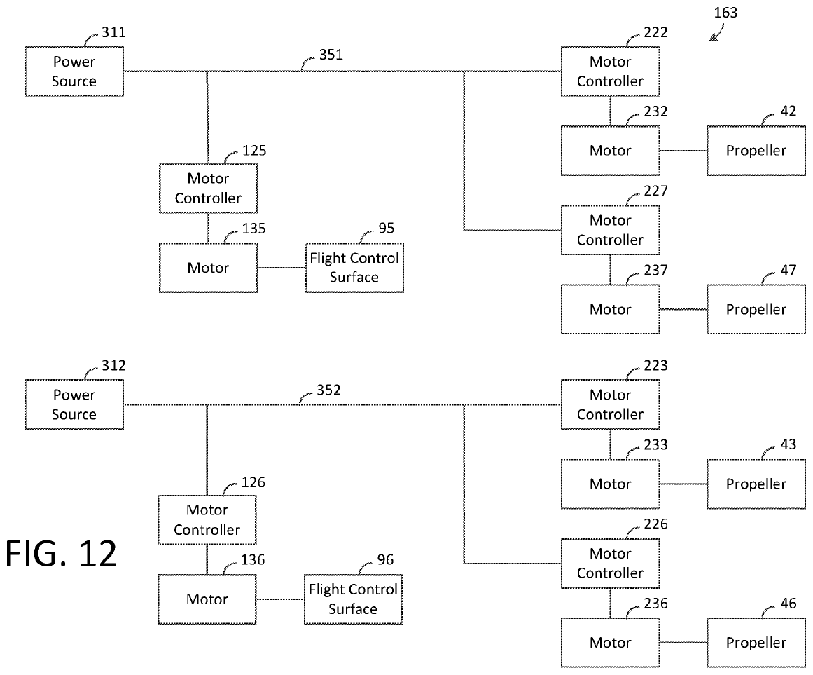

As an example, referring to FIG. 12, the bus 351 is electrically coupled to the motor controller 125 and the motor 135 used to actuate the flight control surface 95. Thus, the power source 311 is used to power operation of the flight control surface 95 on the rear wing 25, as well as the inner diagonally-opposed propellers 42, 47. In addition, the bus 352 is electrically coupled to the motor controller 126 and the motor 136 used to actuate the flight control surface 96. Thus, the power source 312 is used to power operation of the flight control surface 96 on the rear wing 26, as well as the inner diagonally-opposed propellers 43, 46. Note that similar effects could be achieved by reversing the pairings for the outer propellers such that the motor controller 125 and the motor 135 are electrically coupled to the bus 352 and such that the motor controller 126 and the motor 136 are electrically coupled to the bus 351.

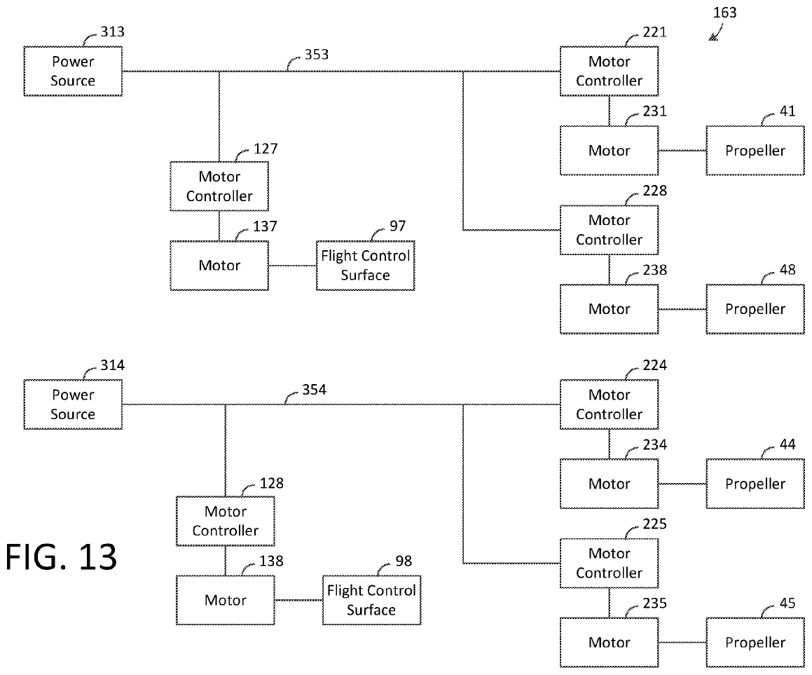

In addition, referring to FIG. 13, the bus 353 is electrically coupled to the motor controller 127 and the motor 137 used to actuate the flight control surface 97. Thus, the power source 313 is used to power operation of the flight control surface 97 on the forward wing 27, as well as the outer diagonally-opposed propellers 41, 48. In addition, the bus 354 is electrically coupled to the motor controller 128 and the motor 138 used to actuate the flight control surface 98. Thus, the power source 314 is used to power operation of the flight control surface 98 on the forward wing 28, as well as the inner diagonally-opposed propellers 44, 45. Note that similar effects could be achieved by reversing the pairings for the inner propellers such that the motor controller 127 and the motor 137 are electrically coupled to the bus 354 and such that the motor controller 128 and the motor 138 are electrically coupled to the bus 353.

Thus, in the exemplary configuration shown by FIGS. 12 and 13, in the event of an electrical fault on bus 351 that prevents further operation of the flight control surface 95 and the inner propellers 42, 47, the overall effect to controllability is less relative to an embodiment in which the bus 351 is electrically coupled to the motor for the flight control surface 95 and the motors for any pair of outer propellers 41, 44, 45, 48. A similar effect to controllability exists for an electrical fault on bus 352. Further, in the event of an electrical fault on bus 353 (FIG. 13) that prevents further operation of the flight control surface 97 and the outer propellers 41, 48, the overall effect to controllability is less relative to an embodiment in which the bus 353 is electrically coupled to the motors for the outer propellers 41, 48 and the motor for either of the flight control surfaces 95, 96 on the rear wings 25, 26. A similar effect to controllability exists for an electrical fault on bus 354.

By intelligently mapping electrical components to electrical buses based on the extent to which such electrical components affect controllability, as described above, the overall effect an electrical fault has on controllability can be reduced. Moreover, using the various techniques described herein, it is possible to design and implement an electrical system 163 that optimizes competing concerns related to costs, performance, and safety.

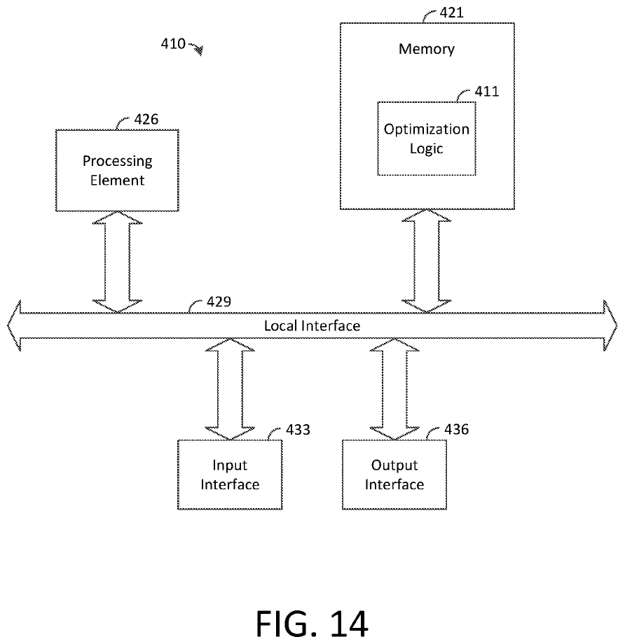

If desired, design of an efficient electrical power system capable of withstanding faults while optimizing certain design parameters of interest may be facilitated using a system that automatically evaluates various designs for different fault conditions. FIG. 14 depicts a computer system 410 having optimization logic 411 for optimizing one or more design parameters in accordance with some embodiments.

The optimization logic 411 can be implemented in software, hardware, firmware or any combination thereof. In the exemplary system 410 illustrated by FIG. 14, the optimization logic 411 is implemented in software and stored in memory 421 of the system 410. The exemplary system 410 depicted by FIG. 14 comprises at least one conventional processing element 426, such as a digital signal processor (DSP) or a central processing unit (CPU), that communicates to and drives the other elements within the system 410 via a local interface 429, which can include at least one bus. Furthermore, an input interface 433, for example, a keyboard or a mouse, can be used to input data from a user of the system 410, and an output interface 436, for example, a printer, monitor, liquid crystal display (LCD), or other display apparatus, can be used to output data to the user.

The optimization logic 411 is configured to receive input data indicative of design variables for an electrical power system that is to provide power for driving propellers of an aircraft. As an example, the optimization logic 411 may receive as input the number of motors 231-238 to be used for driving propellers 41-48 of the aircraft, the number of motor controllers 221-228 to be used for controlling the motors 231-238, the number of electrical buses to carry power from power sources (e.g., batteries 166 or battery packs) to the motor controllers 221-228, and the number of power sources to be used for providing electrical power. The design variables may also include the maximum motor torque for each motor 231-238, and the motor torque for each motor 231-238 for each possible failure case that the system is to be designed to withstand (e.g., a failure of any one or other number of motors 231-238, electrical buses, power sources, etc.). The design variables may also indicate which components may be connected to each other, such as which motors 231-238 may be connected to which motor controllers 221-228, which motor controllers 221-228 may be connected to which electrical buses, and which electrical buses may be connected to which power sources. The design variables may also define an objective, such as a certain parameter or a group of parameters to be maximized, minimized, kept within a certain range, or otherwise controlled. As an example, for illustrative purposes, assume hereafter unless otherwise indicated that an objective is to minimize the weight of the motors 221-228, which may be achieved by finding a design that requires a minimum amount of torque or force from the motors to achieve steady state conditions for various attitudes, as will be described in more detail below.

The optimization logic 411 also receives as input, referred to herein as “torque data,” the amount of change in force along each axis (e.g., x-axis, y-axis, and z-axis) and in moment about each axis with the torque applied to each motor for each of a plurality of attitudes. That is, for each motor 231-238 and each attitude, the torque data indicates how much a given amount of torque applied to the motor results in a force along each axis and results in a moment about each axis. As an example, for hover flight, the propellers may be oriented vertically such that there is a change in force in the z-direction for a given amount of torque applied to a motor but there is no change in force in the x-direction or the y-direction. However, for an attitude for forward flight, much of the force may be applied in the x-direction, depending on angle of attack. Thus, the torque data can be analyzed to determine how much force is generated along each axis and how much moment is generated about each axis for a given amount of torque applied to the motors 221-228 for each of a plurality attitudes (e.g., in hover, in a bank of a certain angle, in a climb or decent at a certain angle, in straight-and-level forward flight, etc.).

The optimization logic 411 also receives as input, referred to herein as “trim data,” the amount of force along each axis (e.g., x-axis, y-axis, and z-axis) and the amount of moment about each axis that is required for steady state conditions for each of the plurality of attitudes. That is, for each attitude, the trim data indicates how much force needs to be applied by the propellers 41-48 along each axis and how much moment needs to be applied by the propellers 41-48 about each axis for the aircraft to achieve steady-state flight conditions. As an example, for hover flight, the trim data may indicate that the aircraft needs to apply an amount of force along the z-axis that is equal to the weight of the aircraft.

The optimization logic 411 further receives input data, referred to herein as “constraint data,” indicative of the constraints for the system. As an example, the constraint data may indicate that the number of motor controllers must be an integer, the number of motor controllers must be equal to or greater than the number of electrical buses, the number of power sources must be equal to or greater than the number of electrical buses, each motor controller 221-228 can control only one motor 231-238, each motor controller 221-228 can be connected to only one electrical bus, and each power source can be connected to only one bus.

In operation, the optimization logic 411 is configured to iteratively process through a plurality of designs for the electrical power system. Each design pertains to a different combination of connectivity for the power sources, electrical buses, motor controllers, and motors, as constrained or limited by design variables and the constraints indicated by the constraint data. A combination of connectivity generally refers to which groups of resources are electrically coupled together. As an example, for one design, motor controllers 221, 222 and motors 231, 232 may be electrically connected to the same electrical bus and power source while the motor controllers 223, 224 and motors 233, 234 may be connected to the same electrical bus and power source. For another design, motor controllers 221, 223 and motors 231, 233 may be electrically connected to the same electrical bus and power source while the motor controllers 222, 224 and motors 232, 234 are electrically connected to the same electrical bus and power source. Since the connectivity among resources is different in the two foregoing examples, each example represents a different design. Note that the number of one resource type connected to another resource type may be different in different designs. As an example, in one design there may be one motor controller per electrical bus such that each electrical bus is connected to a single motor controller. In another connectivity combination, there may be two motor controllers per electrical bus such that each electrical bus is connected to two motor controllers. Other variations are possible in other examples.

For each design defined by the design variables and the constraint data, the optimization logic 411 is configured to iteratively process a plurality of failure conditions that the aircraft 10 is to be designed to withstand, including for example a failure of a certain number (e.g., one or more) of motors 231-238, a failure of a certain number (e.g., one or more) motor controllers 221-228, a failure of a certain number (e.g., one or more) of electrical buses that carry power from the power sources to the motors and motor controllers, a failure of a certain number (e.g., one or more) of power sources, or any combination of failures. For each failure condition, the optimization logic 411 determines whether the corresponding design is capable of generating sufficient forces and moments for achieving steady-state flight conditions for the various attitudes represented by the trim data. As an example, one failure condition may be the failure of the motor 231 driving the propeller 41. Based on the torque data, the optimization logic 411 determines whether the remaining operative propellers 42-48 are capable of generating sufficient forces and moments for steady-state flight conditions (as indicated by the trim data) for each tested attitude. The designs incapable of sufficiently generating such forces and moments for any tested attitude are eliminated as possible candidate designs for the aircraft 10. Of the remaining candidate designs (i.e., designs not eliminated), the optimization logic 411 determines which design achieves the specified objective. As an example, if the specified objective is minimization of motor weight by minimizing the force that each motor 231-238 is required to generate, the optimization logic 411 may identify which candidate design requires the least amount of force from each motor 231-238 for all of the tested attitudes. The optimization logic 411 may provide an output via output interface 436 indicative of such candidate design helping a user to select a design to achieve or satisfy the stated objective. The optimization logic 411 may also output data from its calculations, such as the amount of force required by each motor 231-238 for each tested attribute, as calculated by the optimization logic 411, for analysis by a user. In other examples, other types of information may be provided optimization logic 411 in other embodiments.

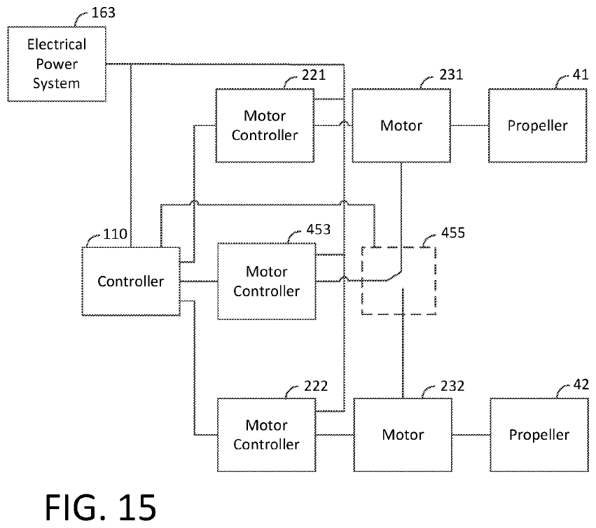

In the exemplary embodiment depicted above for FIG. 3, there is one motor controller 221-228 per motor 231-238 for driving the propellers 41-48. As noted above, there may be any number of motor controllers coupled to a motor. In addition, it is possible to selectively couple a motor controller to multiple motors. As an example, FIG. 15 shows an embodiment for which a motor controller 453 is selectively coupled by a switch 455 to a pair of motors 231, 232 for respectively driving propellers 41, 42. The switch 455 may be configured to operate under the direction and control of the controller 110 to electrically couple the motor controller 453 to the motor 231 at times and alternatively to electrically coupled the motor controller 453 to the motor 232 at other times, as will be described in more detail below.

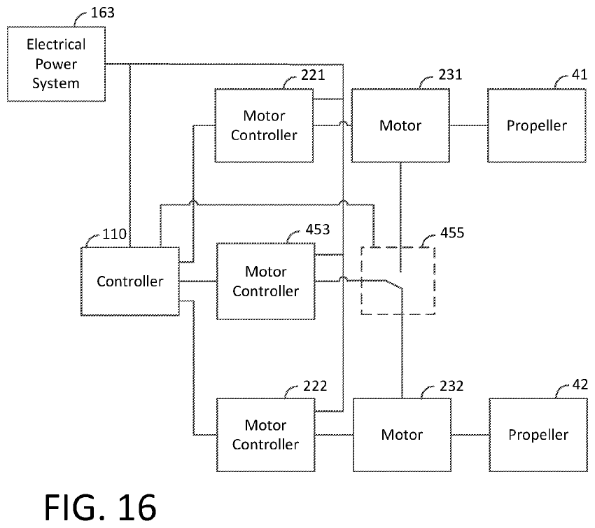

When the motor controller 453 is coupled to the motor 231 as shown by FIG. 15, the motor 231 may receive electrical power from both the motor controller 221 and the motor controller 453. During such times, the motor 231 may drive the propeller 41 with more power and thus achieve a higher blade rotation speed for the propeller 41 resulting in greater thrusts and moments from the propeller 41 relative to the configuration shown by FIG. 15. Similarly, when the motor controller 453 is coupled to the motor 232 as shown by FIG. 16, the motor 232 may receive electrical power from both the motor controller 222 and the motor controller 453. During such times, the motor 232 may drive the propeller 42 with more power and thus achieve a higher blade rotation speed for the propeller 42 resulting in greater thrusts and moments from the propeller 42 relative to the configuration shown by FIG. 15.

There are various benefits and advantages that can be realized by having a motor controller 453 selectively coupled to multiple motors 231, 232, as shown by FIGS. 15 and 16. As an example, it is possible to use smaller motor controllers 221, 222, 453 (e.g., rated for a smaller amount of power) and still achieve the same or similar peak power for driving the propellers 41, 42 relative to an embodiment, such as depicted by FIG. 3, where there is one motor controller 221-228 per motor 231-238. As an example, for illustrative purposes, assume that each motor controller 221-228 is rated to provide 50 kilo-Watts (kW) of power in FIG. 3. In such an embodiment, each motor 231-238 may receive a maximum of 50 kW. In FIG. 15, assume that each motor controller 221, 222, 453 is rated to provide 25 kW of power. Thus, smaller, less-expensive electrical components (e.g., circuitry) may be used to implement the motor controllers 221, 222, 453 in FIG. 15. In addition, by using smaller components, the motor controllers 221, 222, 453 may weigh less. However, in both embodiments, the each motor 231, 232 is capable of receiving the same maximum power (i.e., 50 kW), though not both at the same time in the embodiment depicted by FIG. 15.

In normal operation, the controller 110 may leverage the relative positioning of the propellers 41, 42 to intelligently control the switch 455 to achieve efficient use of the power available through the motor controllers 221, 222, 453. In this regard, as noted above, the propellers 41, 42 provide different moments since they are located at different distances from the aircraft's center of gravity. When the controller 110 is attempting to perform a flight maneuver (e.g., a rolling motion, a pitching motion, and/or a yawing motion), it may be desirable to operate one propeller 41, 42 at a higher blade speed than the other in order to achieve the desired movement or effect. In such case, the controller 110 may control the switch 455 such that it electrically couples the motor controller 453 to the motor 231, 232 driving the propeller 41, 42 that is to operate at the higher blade speed. Thus, the switch 455 can be controlled to increase the peak power for driving the propeller that is to operate at a higher blade speed, thereby increasing the forces and moments that this propeller is capable of providing for controllability.

In addition, if there is a failure associated with one of the motors 231, 232, the switch 455 can be controlled to electrically couple the motor controller 453 to the other operable motor so that electrical power from the motor controller 453 is not directed to the failed motor. In this regard, the system may include one or more sensors (not shown) in FIG. 15 for sensing when the motors 231, 232 or propellers 41, 42 fail and reporting any such failure to the controller 110. If there is a failure sensed for either the motor 231 or the propeller 41, the controller 110 may be responsive to such failure for controlling the switch 455 such that it electrically couples the motor controller 453 to the motor 232 for driving the propeller 42 that is still functioning. Similarly, if there is a failure sensed for either the motor 232 or the propeller 42, the controller 110 may be responsive to such failure for controlling the switch 455 such that it electrically couples the motor controller 453 to the motor 231 for driving the propeller 41 that is still functioning.

The use of the motor controller 453 also provides operational redundancy for the motor controllers 221, 222. In this regard, the system may include one or more sensors (not shown in FIG. 15) for sensing when the motor controllers 221, 222 fail and reporting any such failure to the controller 110. The controller 110 may be responsive to such failure for controlling the switch 455 such that it electrically couples the motor controller 453 to the motor 231 that is connected to the failed motor controller 221, 222. Thus, the motor 231, 232 that is coupled to the failed motor controller 221, 222 may continue to operate (albeit at a lower peak power) despite the failure. As an example, if the motor controller 221 fails, the motor controller 453 may be electrically coupled to the motor 231, and if the motor controller 222 fails, the motor controller 453 may be electrically coupled to the motor 232.

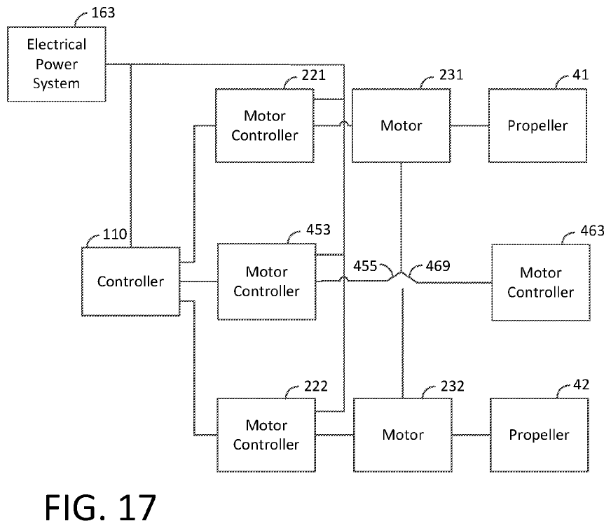

In FIG. 15, the motor controller 453 is shown as selectively coupled to motors 231, 232 by the switch 455. These motors 231, 232 drive propellers 41, 42 that are on the same wing 25, which may help to facilitate wiring for the embodiment shown by FIG. 15. However, it should be noted that the motor controller 453 may be selectively coupled between any two motor controllers 221-228 as may be desired. Further, it is possible to be selectively coupled among any number of motors 221-228 (e.g., more than two). It is also possible for more than one motor controller to be selectively coupled to the same set of motors. As an example, FIG. 17 shows the embodiment of FIG. 15 with an additional motor controller 463 that is selectively coupled to the motors 231, 232, by a switch 469 as described above for the motor controller 453. In this regard, the controller 110 may control the switch 469 such that it electrically couples the motor controller 463 to either motor 231, 232 at any given time. Both motor controllers 453, 463 may be electrically coupled to the same motor 231 as shown by FIG. 17 to provide maximum power to such motor 231. Alternatively, one of the motor controllers 453, 463 may be electrically coupled to one motor 231, 232 while the other motor controller 453, 463 is electrically coupled to the other one.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

1. An electrically-powered aircraft, comprising:
a fuselage;
a plurality of wings coupled to the fuselage in a tandem-wing configuration;
a first power source;
a second power source;
a first pair of diagonally-opposed propellers including a first propeller coupled to a first forward wing of the plurality of wings and a second propeller coupled to a first rear wing of the plurality of wings;
a first motor coupled to the first propeller for driving the first propeller;
a second motor coupled to the second propeller for driving the second propeller;
a second pair of diagonally-opposed propellers including a third propeller coupled to a second forward wing of the plurality of wings and a fourth propeller coupled to a second rear wing of the plurality of wings;
a third motor coupled to the third propeller for driving the third propeller;
a fourth motor coupled to the fourth propeller for driving the fourth propeller;
a first electrical bus electrically coupled to the first power source, the first motor and the second motor; and
a second electrical bus electrically coupled to the second power source, the third motor, and the fourth motor, wherein the second electrical bus is electrically isolated from the first electrical bus.

2. The electrically-powered aircraft of claim 1, wherein the first pair of diagonally-opposed propellers is configured to generate corresponding pitch moments and roll moments on opposite sides of the fuselage such that pitch and roll of the aircraft remain balanced when an electrical fault affects operation of each of the first pair of diagonally-opposed propellers.

3. The electrically-powered aircraft of claim 1, wherein the first pair of diagonally-opposed propellers and the second pair of diagonally-opposed propellers are mounted on the aircraft in a quad arrangement.

4. The electrically-powered aircraft of claim 1, wherein the electrically-powered aircraft is self-piloted.

5. The electrically-powered aircraft of claim 1, further comprising:
a first fuse coupled to the first electrical bus in series with at least one battery of the first power source;
a second fuse coupled to the first electrical bus in series with the first motor; and
a third fuse coupled to the first electrical bus in series with the second motor.

6. The electrically-powered aircraft of claim 5, wherein at least one of the first fuse, the second fuse, and the third fuse is a pyrotechnic fuse.

7. The electrically-powered aircraft of claim 1, further comprising:
a third power source;
a third pair of diagonally-opposed propellers including a fifth propeller coupled to the first forward wing and a sixth propeller coupled to the first rear wing;
a fifth motor coupled to the fifth propeller for driving the fifth propeller;
a sixth motor coupled to the sixth propeller for driving the sixth propeller; and
a third electrical bus electrically coupled to the third power source, the fifth motor and the sixth motor.

8. The electrically-powered aircraft of claim 7, further comprising:
a fourth power source;
a fourth pair of diagonally-opposed propellers including a seventh propeller coupled to the second forward wing and an eighth propeller coupled to the second rear wing;
a seventh motor coupled to the seventh propeller for driving the seventh propeller;
an eighth motor coupled to the eighth propeller for driving the eighth propeller;
a fourth electrical bus electrically coupled to the fourth power source, the seventh motor, and the eighth motor, wherein each of the first electrical bus, the second electrical bus, the third electrical bus, and the fourth electrical are electrically isolated from each other.

9. The electrically-powered aircraft of claim 8, wherein the first pair of diagonally-opposed propellers and the second pair of diagonally-opposed propellers are mounted on the electrically-powered aircraft in an inner quad arrangement, and wherein the third pair of diagonally-opposed propellers and the fourth pair of diagonally-opposed propellers are mounted on the electrically-powered aircraft in an outer quad arrangement.

10. The electrically-powered aircraft of claim 9, further comprising:
a first flight control surface positioned on the plurality of wings;
a ninth motor coupled to the first flight control surface for actuating the first flight control surface, the ninth motor electrically coupled to one of the first electrical bus and the second electrical bus;
a second flight control surface positioned on the plurality of wings, the second flight control surface having a surface area greater than a surface area of the first flight control surface; and
a tenth motor coupled to the second flight control surface for actuating the second flight control surface, the tenth motor electrically coupled to one of the third electrical bust and the fourth electrical bus.

11. A method for powering electrical components of an aircraft having a plurality of wings in a tandem-wing configuration, the aircraft having a first pair of diagonally-opposed propellers including a first propeller coupled to a first forward wing of the plurality of wings and a second propeller coupled to a first rear wing of the plurality of wings, the aircraft having a second pair of diagonally-opposed propellers including a third propeller coupled to a second forward wing of the plurality of wings and a fourth propeller coupled to a second rear wing of the plurality of wings, the method comprising:
providing electrical power across a first electrical bus from a first power source to a first motor and a second motor;
driving the first propeller with the first motor;
driving the second propeller with the second motor;
providing electrical power across a second electrical bus from a second power source to a third motor and a fourth motor, wherein the second electrical bus is electrically isolated from the first electrical bus;
driving the third propeller with the third motor; and
driving the fourth propeller with the fourth motor.

12. The method of claim 0, wherein the first pair of diagonally-opposed propellers and the second pair of diagonally-opposed propellers are mounted on the aircraft in a quad arrangement.

13. The method of claim 0, wherein the aircraft is self-piloted.

14. The method of claim 0, further comprising:
automatically transitioning a fuse coupled to the first electrical bus from a short-circuit state to an open-circuit state in response to a voltage or current of a signal on the first electrical bus exceeding a threshold.

15. The method of claim 14, wherein the fuse is a pyrotechnic fuse.

16. The method of claim 0, wherein the aircraft has a third pair of diagonally-opposed propellers including a fifth propeller coupled to the first forward wing and a sixth propeller coupled to the first rear wing, the method further comprising:
providing electrical power across a third electrical bus from a third power source to a fifth motor and a sixth motor;
driving fifth propeller with the fifth motor; and
driving the sixth propeller with the sixth motor.

17. The method of claim 16, wherein the aircraft has a fourth pair of diagonally-opposed propellers including a seventh propeller coupled to the second forward wing and an eighth propeller coupled to the second rear wing, the method further comprising:
providing electrical power across a fourth electrical bus from a fourth power source to a seventh motor and an eighth motor;
driving the seventh propeller with the seventh motor; and
driving the eighth propeller with the eighth motor.

18. The method of claim 17, wherein the first pair of diagonally-opposed propellers and the second pair of diagonally-opposed propellers are mounted on the aircraft in an inner quad arrangement, and wherein the third pair of diagonally-opposed propellers and the fourth pair of diagonally-opposed propellers are mounted on the aircraft in an outer quad arrangement.

19. The method of claim 18, further comprising:
providing electrical power across one of the first electrical bus and the second electrical bus to a ninth motor;
actuating, with the ninth motor, a first flight control surface positioned on the plurality of wings;
providing electrical power across one of the third electrical bus and the fourth electrical bus to a tenth motor; and
actuating, with the tenth motor, a second flight control surface positioned on the plurality of wings, the second flight control surface having a surface area greater than a surface area of the first flight control surface.

20. (canceled)

21. (canceled)

22. A system for driving propellers on an aircraft, comprising:
a first propeller mounted on the aircraft;
a first motor coupled to the first propeller for driving the first propeller;
a first motor controller coupled to the first motor for supplying electrical power to the first motor;
a second propeller mounted on the aircraft;
a second motor coupled to the second propeller for driving the second propeller;
a second motor controller coupled to the second motor for supplying electrical power to the second motor; and
a third motor controller selectively coupled by a switch to the first motor for supplying electrical power to the first motor and to the second motor for supplying electrical power to the second motor.

23. The system of claim 22, wherein the first propeller is mounted on a wing of the aircraft, and wherein the second propeller is mounted on the wing.

24. The system of claim 22, further comprising a controller configured to control the switch in response to a failure of the first motor or the first propeller such that the third motor controller is electrically coupled to the second motor.

25. The system of claim 22, further comprising a controller configured to control the switch in response to a failure of the first motor controller such that the third motor controller is electrically coupled to the first motor.

26. The system of claim 22, further comprising a controller configured to select one of the first motor and the second motor based on a desired flight maneuver for the aircraft and to control the switch such that the selected motor is electrically coupled to the third motor controller.

27. The system of claim 22, further comprising a fourth motor controller selectively coupled by a switch to the first motor for supplying electrical power to the first motor and to the second motor for supplying electrical power to the second motor.

28. A method for driving propellers on an aircraft, comprising:
driving a first propeller mounted on the aircraft with a first motor;
supplying electrical power to the first motor with a first motor controller;
driving a second propeller mounted on the aircraft with a second motor;
supplying electrical power to the second motor with a second motor controller;
selectively coupling a third motor controller to the first motor and the second motor;
supplying electrical power to the first motor with the third motor controller; and
supplying electrical power to the second motor with the third motor controller.

29. The method of claim 28, wherein the first propeller is mounted on a wing of the aircraft, and wherein the second propeller is mounted on the wing.

30. The method of claim 28, wherein the selectively coupling comprises electrically coupling the third motor controller to the second motor in response to a failure of the first motor or the first propeller.

31. The method of claim 28, wherein the selectively coupling comprises electrically coupling the third motor controller to the first motor in response to a failure of the first motor controller.

32. The method of claim 28, further comprising:
selecting one of the first motor and the second motor based on a desired flight maneuver, wherein the selectively coupling comprises electrically coupling the selected motor to the third motor controller based on the selecting.

33. The method of claim 28, further comprising:
selectively coupling a fourth motor controller to the first motor and the second motor;
supplying electrical power to the first motor with the fourth motor controller; and
supplying electrical power to the second motor with the fourth motor controller.
